(19) United States
(12) Patent Application Publication
(10) Pub. No.: US 2008/0285656 A1
(43) Pub. Date: Nov. 20, 2008

(54) THREE-LOOP TEMPORAL INTERPOLATION FOR ERROR CONCEALMENT OF MULTIPLE DESCRIPTION CODING

(75) Inventors: Oscar Chi Lim Au, Kowloon (HK); Mengyao Ma, Kowloon (HK)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: THE HONG KONG UNIVERSITY OF SCIENCE AND TECHNOLOGY, Kowloon (HK)

(21) Appl. No.: 11/750,137

(22) Filed: May 17, 2007

(51) Int. Cl. H04N 11/02

(52) U.S. Cl. 375/240.22; 375/240.01

(57) ABSTRACT

Improved systems and methods for error concealment of multiple description coding (MDC) encoded streams are provided based on a three loop interpolation of lost frames. Error concealment of the present invention can be combined with the error resilience provided by MDC to reconstruct lost frames, such that the propagated error to the following frames is reduced.

### TECHNICAL FIELD

The subject disclosure relates to improved systems and methods for error concealment of multiple description coded streams.

### BACKGROUND

As more communication requires video (e.g., real-time streaming of video, video conferencing, digital television, interactive television, television on cellular handsets, Internet Protocol Television (IPTV), and Internet-based communications such as hypertext transport of World Wide Web (WWW) content, more efficient ways of utilizing existing bandwidth have been developed (e.g., compression). This is because the typical bandwidth allocated or available to a particular transmission medium (e.g., broadcast, cable, telephone lines, Wi-Fi™, WiMAX™, etc.) is much less than the bandwidth typically required for a video stream. Furthermore, as high definition video formats have become popular, the bandwidth imbalance is likely to continue. Video compression is used to efficiently carry video data when such bandwidth constraints are imposed and to efficiently store the video data.

Video is typically represented by a sequence of images, called “frames” or “video frames” that, when played in sequence, present the video. As used herein, a video stream can include both a video and an audio stream or can include other information to be transmitted with the video data. However, the following description of the invention refers simply to the video stream, video frame(s), or video data.

Compression of video can effectively reduce the bandwidth required to transmit digital video. Such encoding allows digitized video sequences to be represented efficiently, allowing more video to be transmitted in a given amount of time over a given channel, or more video to be stored in a given storage medium. This is performed by reducing the bitstream, or video information flow, of the video sequences at a transmitter (e.g., placing the bitstream into a channel or storing into a storage medium) while retaining enough information that a decoder or receiver at the other end of the channel or reading the storage medium can reconstruct the video in a manner adequate for the specific application.

However, such encoding of video can lead to visible and sometimes distracting blocky artifacts in the decoded video. As further detailed below, because subsequent frames are dependent on information carried in previous frames, a lost frame (such as that caused by an error in the transmission medium) can lead to propagated errors in the decoded video frames. As a result, techniques have been developed to withstand such lost frames (known as Error Resilience (ER) techniques), and conceal errors that would otherwise result (known as Error Concealment (EC) techniques).

Several ER methods have been developed for video communication, such as Forward Error Correction (FEC), Layered Coding, and Multiple Description Coding (MDC). MDC can be used as an ER technique for video coding. In case of errors, EC can be further combined with MDC to reconstruct the lost frame, such that the propagated error to the following frames is reduced.

Error Resilience (ER) and Error Concealment (EC) techniques are very important for video transmission today, due to the use of predictive coding and Variable Length Coding (VLC) in video compression. FIG. 1 illustrates different approaches for video coding, in which the arrow indicates that the previous frame is used as the reference of the latter. The conventional INTER mode approach 100A (e.g., Single Description Coding (SDC)) is illustrated in FIG. 1A, where each P frame is predicted from its immediate previous frame. Although the compression efficiency of this approach is high, it is highly vulnerable to errors in the transmission channel. For continuous losses at the decoder side, the typical concealment method is to copy the previous frame to reconstruct the video, resulting in a temporary freeze. However, if one frame is lost or corrupted (e.g., P₄ at 102_A) during the transmission, the error in the reconstructed frame at the decoder will propagate to the remaining frames (e.g., P₅−P₁₀) until the next I-frame (I₁₁ at 104_A) is received. Different from the traditional SDC, temporal MDC divides the video stream into equally important streams (descriptions), which are sent to the destination through different channels. One simple implementation is the odd/even sub-sampling approach as illustrated in FIG. 1B. When the odd/even sub-sampling is used in temporal MDC, an even frame is predicted from the previous even frame, and an odd frame is predicted from the previous odd frame. Then these two streams are sent to the decoder through different channels. Suppose the failure probability of each channel is independent. Then if the n^{th} frame is lost during the transmission, its neighboring frames may be correct, which can be used to reconstruct it by temporal interpolation

One drawback of temporal MDC is that because the reference frames are farther away from the frame of interest in time, the prediction of such approach is not as good as the conventional codec and the compression efficiency is lower. However, because each stream is separately encoded and transmitted, the corruption of one stream will not affect the other (providing the benefit of ER). The decoder can then simply display the correct video stream (P₅ P₇ P₉ . . . ) at half of the original frame rate, or the decoder can reconstruct the corrupted frame by some appropriate EC methods (e.g., Temporal Interpolation).

Although temporal interpolation was originally used to generate one or more frames between two received frames so as to improve the effective frame rate, and make the object motions smoother in the decoded video, temporal interpolation for EC provides the benefit that it can be well combined with temporal MDC methods. To illustrate this, FIG. 1C depicts the odd/even sub-sampling approach with a dropped frame (e.g., P₄ at 102_C). When frame P₄ at 102_C is corrupted or lost during the transmission, its surrounding frames (P₃ and P₅ at 106_C and 108_C respectively) would be correct if stream 1 is error-free. As a result P₃ and P₅ can be used to interpolate P₄ with good quality. FIG. 2 illustrates a typical block of a lost frame interpolated using temporal interpolation as will be further described in detail below.

One such temporal interpolation method, Motion Compensated Temporal Interpolation (MCTI), uses block-based motion estimation to track motions of the objects between adjacent received frames. However, the method suffers from the aforementioned blocky artifacts. Although improvements to remove the blocky artifacts have been proposed, these methods use both forward and backward motion estimation to find the motion vector, which lead to high computational requirement. Another improvement that has been proposed, Unidirectional Motion Compensated Temporal Interpolation (UMCTI), performs only forward motion estimation, and thus saves half of the computation time.

The advantage of introducing UMCTI to temporal MDC is that the exhaustive motion estimation needs not be performed at all, since the motion vectors from blocks of the (n+1)^{th} frame to the corresponding blocks in the (n−1)^{th} frame is known. In other words, the motion vector from P₅ to P₃ (at 108₁₃ C and 106_C respectively) is conserved in stream 1, as in the example of FIG. 1C. However, as will be shown in more detail below, UMCTI still leaves room to improve the decoded video quality by removing the remaining artifacts and improving the Peak Signal to Noise Ratio (PSNR).

### SUMMARY

In consideration of the foregoing disadvantages of conventional coding approaches, the invention provides improved error concealment systems and methods based on a three loop interpolation of lost frames (herein referred to as Three-loop Temporal Interpolation (TLTI)). Error concealment of the present invention can be combined with the error resilience provided by MDC to reconstruct lost frames, such that the propagated error to the following frames is reduced.

TLTI utilizes the preserved motion vector in the correct stream for EC, and can be well combined with temporal sub-sampling ER methods (e.g., MDC and Alternative Motion-Compensated Prediction (AMCP)). TLTI requires three loops to fill the pixel values for the dropped frame.

Briefly, in the first loop, defined determined motion vectors (mv_{d}) for blocks in the lost frame of the corrupted stream are calculated, and where mv_{d} is undefined, candidate motion vectors (mv_{c})s are calculated using the smoothness of the motion vectors (mv_{d}s) of the surrounding blocks. In the second loop, the pixel values are filled in for the blocks having defined mv_{d}s. Then, in the third loop, the remaining blocks are filled as above if they have defined and credible mv_{c}. For those blocks having undefined or incredible mv_{c}, Boundary Matching (BM) can be performed to fill the remaining pixel values.

As a result, TLTI advantageously combines the efficiencies of UMCTI and the ER or MDC with a new three-loop interpolation approach that results in visual and quantitative improvements over traditional EC approaches as will be shown in more detail below.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

The system and methods for error concealment of MDC streams are further described with reference to the accompanying drawings in which:

FIG. 1A illustration of one illustrates a conventional video coding techniques;

FIG. 1B illustrates an odd/even sub-sampling MDC approach;

FIG. 1C illustrates the situation where an error occurs (lost frame 4) in the approach of FIG. 1B;

FIG. 2 illustrates a typical block of a lost frame interpolated using temporal interpolation;

FIG. 3 is an exemplary non-limiting block diagram generally illustrating the improved systems of temporal interpolation for error concealment for MDC encoded streams;

FIG. 4 is an exemplary non-limiting block diagram generally illustrating the improved methods of temporal interpolation for error concealment for MDC encoded streams;

FIG. 5 illustrates an exemplary operation of a pixel fill process in the third loop according to one aspect of the present invention;

FIG. 6A depicts the reference frames of the video sequence Carphone, for one frame lost (frame 3) (e.g., it depicts the original encoded frames 2 and 4 without lost frame);

FIG. 6B depicts the visual results of applying UMCTI and TLTI on the video sequence Carphone (i.e., the reconstructed frame 3) using UMCTI (PSNR=29.79 dB) and TLTI (PSNR=30.33 dB) indicating remaining artifacts in the UMCTI reconstructed frame;

FIG. 6C is an enlarged version of the results in FIG. 6B depicting visual results of applying UMCTI and TLTI on the video sequence Carphone (i.e., the reconstructed frame 3) using UMCTI (PSNR=29.79 dB) and TLTI (PSNR=30.33 dB) indicating remaining artifacts in the UMCTI reconstructed frame;

FIG. 7 illustrates the simulation results for average delta-PSNR between TLTI and UMCTI for different packet loss rate (P=1%, P=3% or P=5%) applying UMCTI and TLTI on the video sequence Carphone;

FIG. 8 illustrates the simulation results for average delta-PSNR between TLTI and UMCTI for different packet loss rate (P=1%, P=3% or P=5%) applying UMCTI and TLTI on the video sequence Sales;

FIG. 9A illustrates a block diagram of an exemplary non-limiting embodiment of a video stream processing system suitable for practicing the present invention where encoded video is transmitted over a channel;

FIG. 9B illustrates a block diagram of an exemplary non-limiting embodiment of a video stream processing system suitable for practicing the present invention where video is encoded/decoded to/from a storage component;

FIG. 10 is a block diagram representing an exemplary non-limiting networked environment in which the present invention may be implemented; and

FIG. 11 is a block diagram representing an exemplary non-limiting computing system or operating environment in which the present invention may be implemented.

### DETAILED DESCRIPTION

### Overview

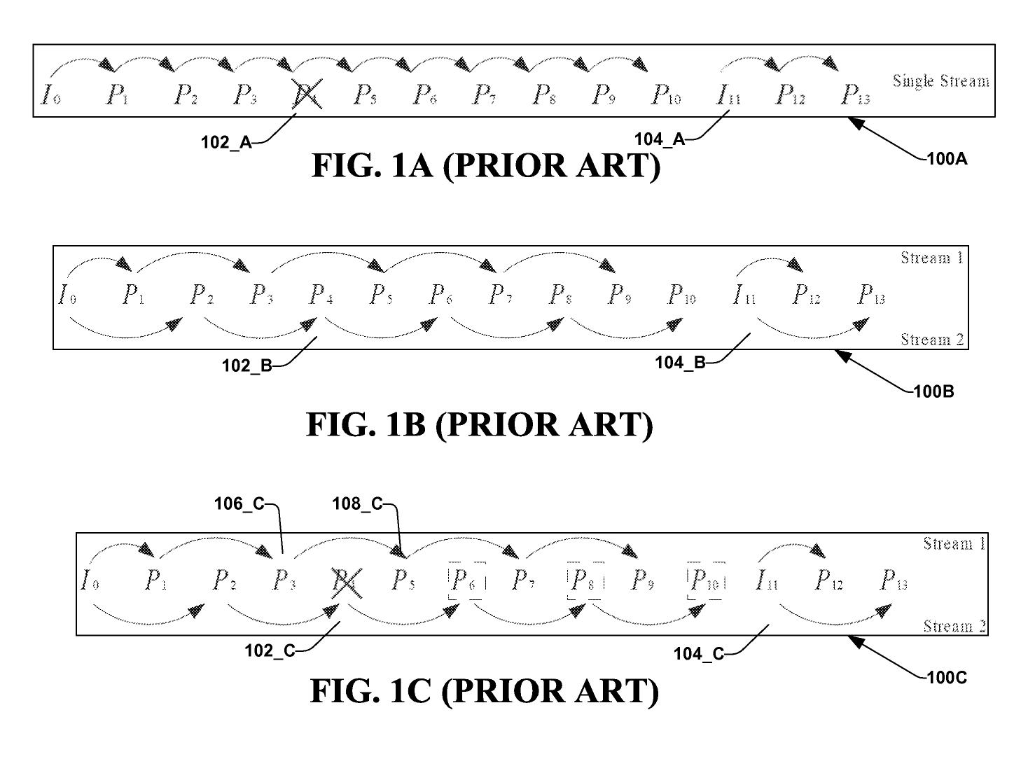

As described above, when the odd/even sub-sampling is used in temporal MDC, an even frame is predicted from the previous even frame, and an odd frame is predicted from the previous odd frame and is sent to the decoder over different channels. Supposing the failure probability of each channel is independent, then if the n^{th} frame is lost during the transmission, its neighboring frames may be correct, which can then be used to reconstruct it by temporal interpolation. Recall that in FIG. 1C, when frame P₄ at 102_C is corrupted or lost during the transmission, its surrounding frames (P₃ and P₅ at 106_C and 108_C respectively) would be correct if stream 1 is error-free. As a result P₃ and P₅ can be used to interpolate P₄ with good quality.

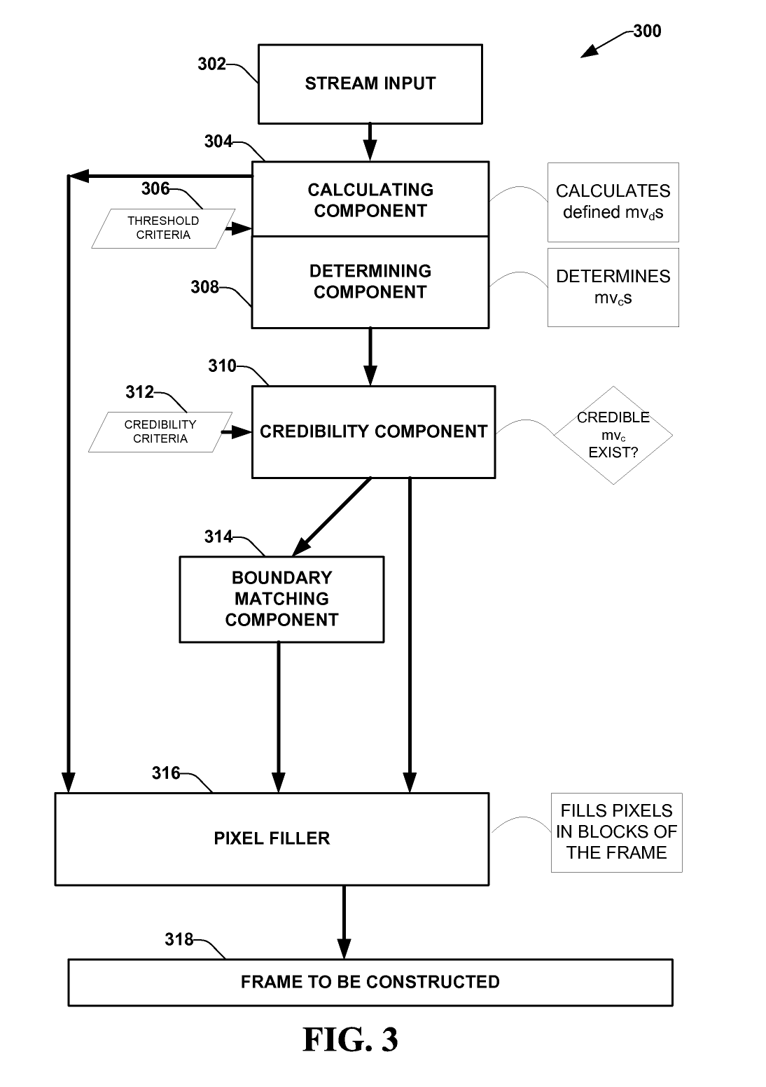

Referring to FIG. 3, an exemplary non-limiting block diagram generally illustrating the improved systems of temporal interpolation for error concealment for MDC encoded streams is provided. According to one aspect of the invention, a stream is received by the system 300 at 302. It is desired to construct or reconstruct a frame using three loop temporal interpolation of the present invention. To that end the calculating component 304 of the claimed system, calculates the defined determined motion vectors (mv_{d}) for blocks in the desired frame of the stream input. According to a further non-limiting embodiment, adjustable thresholds are provided 306 (e.g., a maximum motion vector and minimum block overlap parameter) that enables the system designer to achieve optimal system performance.

The output of the calculating component is provided to the pixel filler 316 for subsequent pixel filing operations as described below. At 308, the determining component determines the candidate motion vectors (mv_{c})s for the undefined determined motion vector block using inputs from the calculating component 304. At 310, the credibility component determines whether credible mv_{c}s exist for the undefined determined motion vector blocks, and provides and input based on the determination to either the boundary matching component 314 or to the pixel filler 316 for subsequent pixel filing operations as described below. For blocks that cannot have pixel values filled directly because they lack a credible mv_{c}, boundary matching is performed to fill such blocks at 314, which output is provided is provided to the pixel filler 316 for subsequent pixel filing operations. In one aspect of the invention, the credibility component is provided with an adjustable credibility criteria (e.g., surrounding motion vector smoothness threshold) that enables the system designer to achieve optimal system performance. According to a further aspect of the invention the boundary matching can be preceded by an edge detection to discard edge blocks to increase the effectiveness of the boundary matching.

At 316, the pixel filler takes inputs from the calculating component 304 for filling the pixel values of the blocks having defined mv_{d}s, from the credibility component 310 for filling the blocks of filling the pixel values of the blocks having credible mv_{c}s, and from the boundary matching component 314 for filling the pixel values of the remaining blocks according to a boundary matching calculation. The pixel filler then constructs the frame from the received inputs at 318.

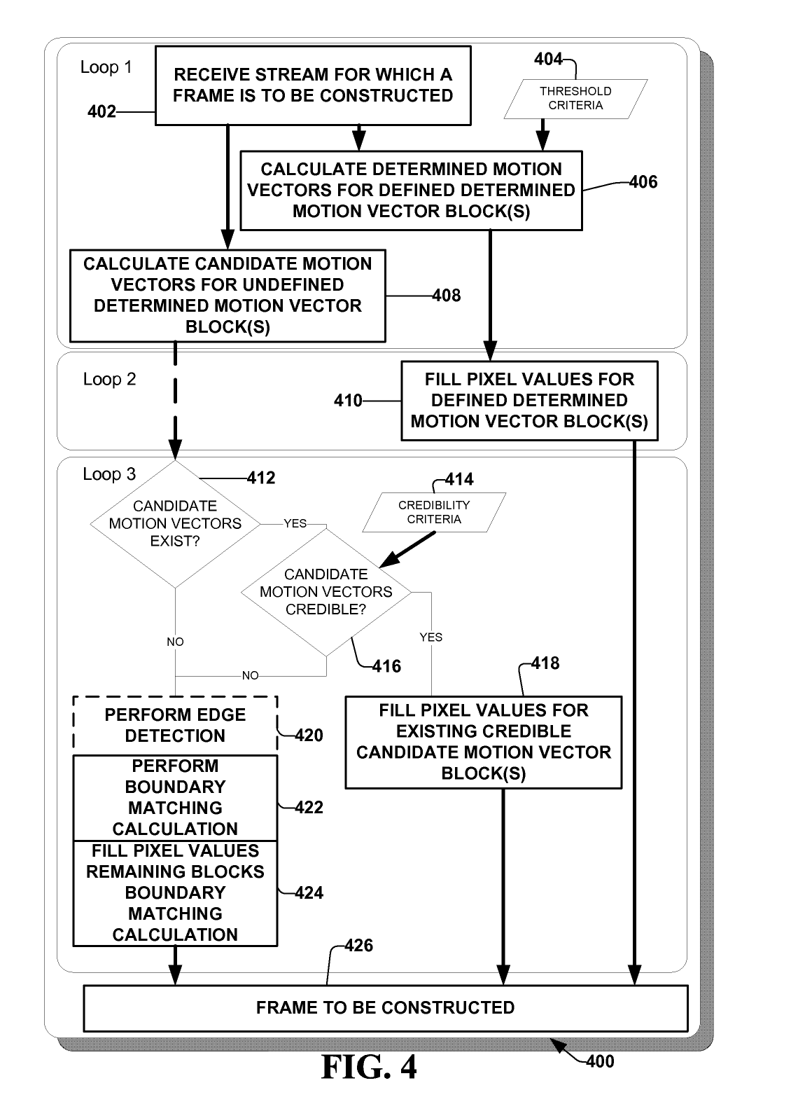

Referring now to FIG. 4 an exemplary non-limiting block diagram generally illustrating the improved methods of temporal interpolation for error concealment for MDC encoded streams is illustrated. Note that the rough grouping of operations in loops (e.g., Loop 1, Loop 2, Loop 3) is provided as an illustrative aid to further understand the more detailed description that follows, and should not be used to limit the claimed invention. Accordingly, at 402 a stream is received for which it is desired to construct a frame. At 406 determined motion vectors for defined determined motion vector block(s) mv_{d}s are calculated and used to fill pixel values 410 for such blocks in the frame 426. At 408, candidate motion vectors mv_{c}s for undefined determined motion vector block(s) are calculated to either use for pixel filling at 418 (by way of the credibility determination at 412 and 416) or to identify blocks for which it is desired to perform boundary matching (420, 422) in order to fill such block's pixel values 424 based on a boundary matching calculation. It should be noted that the calculations at 408 are subject to change as detailed below due to the timing and changes occurring for the neighboring blocks. Furthermore as described above, adjustable threshold criteria 404 and credibility criteria 414 are provided according to one aspect of the invention to enable system designers to achieve optimal system performance. Further details illustrating the improved methods of temporal interpolation for error concealment for MDC encoded streams is provided below.

According to various non-limiting embodiments of the invention, the first loop can use the preserved motion vector in the (n+1)^{th} frame to calculate the defined determined motion vectors (mv_{d}) for blocks in the lost frame of the corrupted stream. According to a further non-limiting embodiment, adjustable thresholds are provided that enable the system designer to achieve optimal system performance. For mv_{d}s that are undefined for the block of interest, then candidate motion vectors (mv_{c})s can be calculated using the smoothness of the motion vectors (mv_{d}s) of the surrounding blocks. Because the values of mv_{d}s may be changed after calculation of mv_{c}, resulting in different mv_{c} than initially calculated, according to a further non-limiting embodiment, the invention provides a mechanism to account for such discrepancies in the third loop. In the second loop, the pixel values can be filled in for the blocks having defined mv_{d}s, according to a further aspect of the invention.

In the third loop, the invention provides for filling the remaining blocks as above if they have defined and credible mv_{c}, according to a further aspect of the invention. According to a further non-limiting embodiment, an adjustable threshold smoothness parameter is provided to enable the system designer to achieve optimal system performance. The invention further provides a mechanism to test the credibility of mv_{c} by testing whether the smoothness of mv_{c} for the current block and its surrounding neighbors still holds according to the threshold smoothness parameter. For those blocks having undefined or incredible mv_{c}, BM can be performed to fill the pixel values, according to a further aspect of the invention.

According to a particular embodiment, the set of thresholds selected for use in TLTI to implement the disclosed systems and methods can be fixed. However, other possibilities for improvement may arise from the use of variable thresholds, which could be changed (e.g., according to the statistics of each block) and thus further improve the interpolated video quality.

### Three-Loop Temporal Interpolation (First Loop)

Although the present invention may be implemented using any M by N block size, where M (N) is a factor of the image height (width), according to various non-limiting embodiments of the invention, a 4×4 block size can be used for TLTI instead of dividing the lost frame into 16×16 blocks as in UMCTI. Advantageously, the smaller block size can reduce the blocky artifact, but also it can adapt to the multiple block sizes of H.264. Each 4×4 block has two motion vectors (e.g., one is the determined motion vector mv_{d}, and the other one is the candidate motion vector mv_{c}. Both of them are initialized to be an Undefined Number (e.g. ∞).

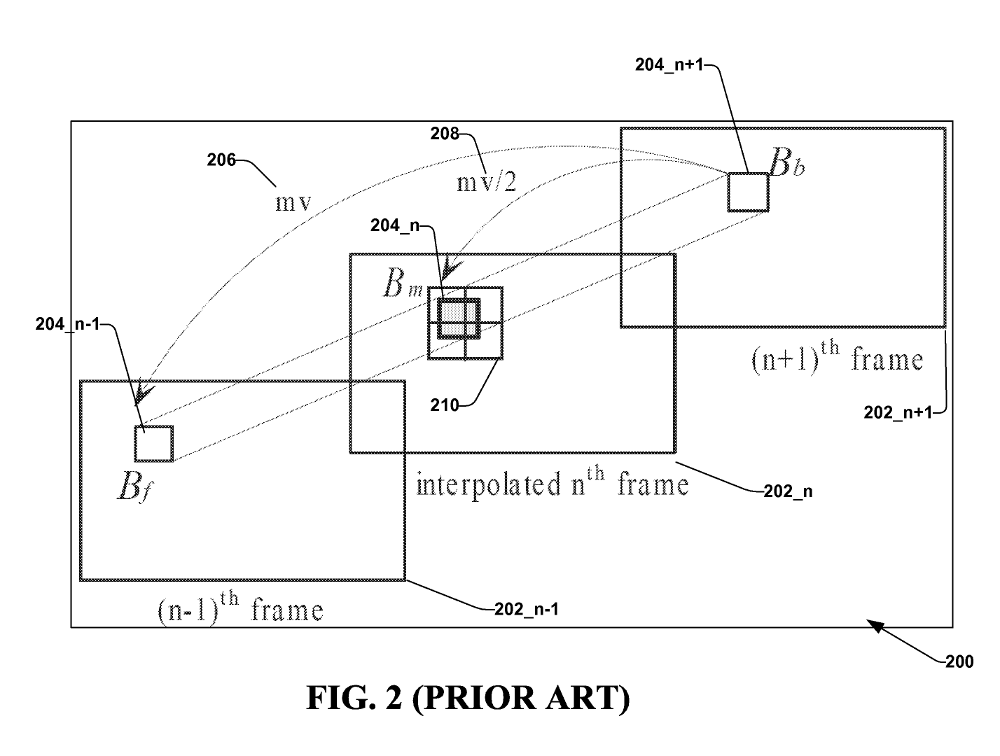

According to various non-limiting embodiments of the invention, the invention fills the pixel values of the lost n^{th} frame in three loops. Referring back to FIG. 2 a typical block of a lost frame interpolated using temporal interpolation is illustrated. The invention provides that the first loop occurs as follows. First, according to various non-limiting embodiments of the invention, the systems and methods determine mv_{d} of possible blocks. As illustrated in FIG. 2, each 4×4 block (B_{b} at 204_{—}n+1) in the (n+1)^{th} frame 202_{—}n+1 has a motion vector mv 206 pointing to the (n−1)^{th} frame 202_{—}n−1. If the motion is linear translation, the corresponding block in the n^{th} frame should be Bₘ 204_{—}n, (e.g., the shaded area indicated by ½mv 208).

As Bₘ 204_{—}n may not align to the grid, it can overlap one or more blocks 210. According to one aspect of the invention, the systems and methods can divide the blocks in the n^{th} frame into two sets: (e.g., set O contains the blocks that overlap with the region, indicated by ½mv 208 of some block in the (n+1)^{th} frame 202_{—}n−1; set N contains the remaining blocks). For any block Bₙⁱ ε O, the invention can find its motion vector mv_{di}ⁿ to the (n−1)^{th} frame 202_{—}n−1 for the interpolation (or a surrogate as below). For example, for Bₙⁱ, n indicates a block in the n^{th} frame 202_{—}n and i is its index in set O. Initially, it can be appreciated that the motion vector of the block which has the largest overlapped region with Bₙⁱ can be used to determine mv_{di}ⁿ according to Equation 1.

$${mv}_{di}^{n} = \frac{1}{2} {mv}_{dm}^{n + 1} , where {size}_{i} ( m ) = {max}_{{B}_{j}^{n + 1} ∈ {P}^{i}} {size}_{i} ( j ) . \qquad Eqn . 1$$

Here Πⁱ is the set of blocks in the (n+1)^{th} frame whose ½mv 208 is pointing to an area overlapped with Bₙⁱ, the motion vector of Bⱼⁿ⁺¹ is mvⱼⁿ⁺¹, and sizeᵢ(j) is the overlapped region size between Bₙⁱ and the area indicated by ½mvⱼⁿ⁺¹.

However, experimental results show that it is not stable to only use the overlapped region size to determine the motion vector. One reason is that the maximum region size is sometimes too small to be credible; another reason is the motion vector preserved in the (n+1)^{th} frame is not reliable, due to the unknown motion estimation method in the encoder side. According to a further non-limiting embodiment, the invention introduces a new definition of Πⁱ in Equation 2 where Πⁱ* is

{Bⱼⁿ⁺¹|Bⱼⁿ⁺¹ ε Πⁱ[_{&} ∥mvⱼⁿ⁺¹∥≦MVᵢ & sizeᵢ (j)≧SIZEₜ}, Eqn. 2

where SIZEₜ and MVₜ are two thresholds. mv_{di}ⁿ is still determined by Equation 1, with Πⁱ replaced by Πⁱ*. Advantageously, the introduction of the two threshold parameters allows a system designer to optimize system performance, according to a further aspect of the invention.

A necessary result of modifying Π¹ is that the mv_{d}s of some blocks in set O may be not be defined in the first loop. For example, due to its definition, Πⁱ* can be an empty set, and thus make the value of mv_{di}ⁿ undefined. For these blocks, the systems and methods provide saving their candidate motion vectors, according to a further aspect of the invention. Instead of using the overlapped region size to decide mv_{c}, the invention uses the smoothness of the motion vectors of neighboring blocks (top, down, left, right) as the selection criterion, according to a further aspect of the invention. For example, it can be appreciated that for Bₙⁱ ε O its candidate motion vector can be determined by Equation 3.

$${mv}_{ci}^{n} = {mv}_{l}^{n + 1} , where {MD}_{i} ( l ) = {min}_{{B}_{j}^{n + 1} ∈ {P}^{i}} {MD}_{i} ( j ) . \qquad Eqn . 3$$

Here MDᵢ(j) is the minimum Euclidean Distance between ½mvⱼⁿ⁺¹ and the mv_{d}s of the four neighbors of Bₙⁱ. According to a further aspect of the invention, if one neighbor does not exist, or its mv_{d} is not defined, the Euclidean Difference is defined to be ∞.

According to one aspect of the invention, the motion vectors of the blocks in O can be determined by maintaining two lists for each block: one for mv_{d} and the other for mv_{c}. Then the values of mv_{d} can be determined first using Equation 1, followed by the determination of mv_{c} using Equation 3.

However, the disadvantage of this approach is that large memory is needed to save all the possible motion vectors. Accordingly, a further non-limiting embodiment of the invention provides for determining the motion vectors using less memory by providing only one more buffer (sz) for each block to save the overlapped region size. For example, the systems and methods can visit all the blocks in the (n+1)^{th} frame, from top to bottom and from left to right. For any block B_{b}, the provided systems and methods can find its corresponding blocks in the n^{th} frame using ½mv, as in FIG. 2. For each of these blocks (e.g., at most 4), the systems and methods can update its mv_{d} using the criteria in Equation 1. Because only one mv_{d} is saved, buffer sz is needed to save the largest overlapped region size. If mv_{d} can not be determined, i.e. Πⁱ* is empty, criteria in Equation 3 can be used to update mv_{c}.

Although this implementation needs less memory, the value of mv_{c} of some blocks may be incorrect after the first loop. For example, the mv_{ci}ⁿ value is related to the mv_{d}s of the four neighbors of Bₙⁱ, which may be changed after the updating of mv_{ci}ⁿ. As a result, mv_{ci}ⁿ can be different from the one determined from Equation 3. As a result, this problem can be addressed in the third loop according to one aspect of the invention.

### Three-Loop Temporal Interpolation (Second Loop)

According to various non-limiting embodiments of the invention, pixel values can be filled in for blocks having defined mv_{d}, after the first loop (and for existing and credible mv_{c} as will be further described below). Accordingly, the pixel values blocks in set O having defined mv_{d}, can be filled according to Equation 4.

$${p}^{n} ( i , j ) = \frac{1}{2} [ {p}^{n - 1} ( i + dx , j + dy ) + {p}^{n + 1} ( i - dx , j - dy ) ] , \qquad Eqn . 4$$

where pⁿ(i, j) is the pixel value of the n^{th} frame at position (i,j), and (dx, dy) is the vector representation of mv_{d}. Advantageously, these filled blocks can help the BM process in the third loop, according to a further aspect of the invention.

### Three-Loop Temporal Interpolation (Third Loop)

According to various non-limiting embodiments of the invention, the unfilled blocks remaining after the previous loop can be filled in at least two ways for EC, depending on whether mv_{c} is available and credible.

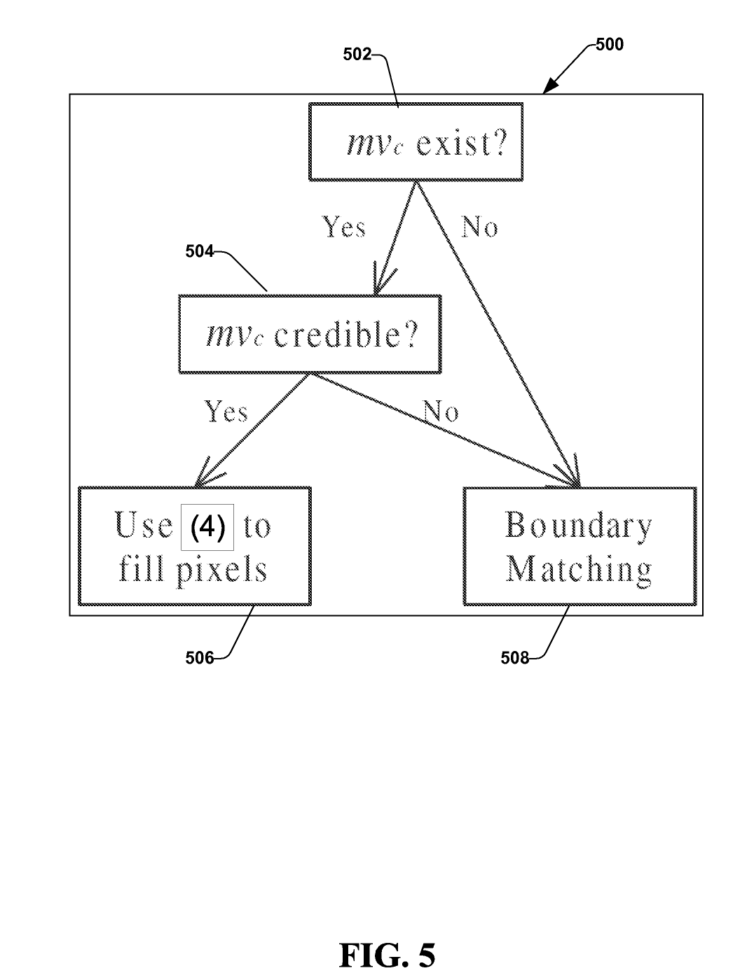

Referring to FIG. 5, an exemplary operation of a pixel fill process in the third loop according to one aspect of the present invention is illustrated. At 502, the systems and methods determine whether mv_{c} exists for a block of interest. If it exists, the mv_{c} is tested against a credibility criteria 504. If mv_{c} both exists and is determined to be credible, then the systems and methods use Equation 4 at 506, for example, to fill the pixel values for the block. If either mv_{c} does not exist or is determined to be incredible, then BM or similar approaches can be used to fill the pixel values at 508.

For example, as noted previously, the mv_{c}s of some blocks may not be correct after the first loop. So for each block with mv_{c}, according to one aspect of the invention, the provided systems and methods can test first to determine whether its mv_{c} is Credible (e.g., the smoothness of the motion vectors between the current block and its neighbors still holds) according to Equation 5.

$${min}_{i ∈ \{ u , d , l , r \}} ‖ {mv}_{c} - {mv}_{i} ‖ \leq {Δ}_{t} , \qquad Eqn . 5$$

where u, d, l, r are the indexes of the four neighbors, and mvᵢ represents their respective motion vectors used in filling pixels, and Δₜ is a threshold. Advantageously, the introduction of the threshold parameter allows a system designer to optimize system performance, according to a further aspect of the invention.

In case one neighbor does not exist, or it has not been filled, the Euclidean Difference is defined to be ∞. After the smoothness testing, if mv_{c} is Credible, Equation 4 can be used to fill the pixel values, with (dx, dy)=mv_{c}. Otherwise, BM or similar approaches can be used can be used to fill the pixel values.

For example, BM can estimate lost motion vectors (e.g., using minimum boundary variance as the criteria). According to a further non-limiting embodiment, the systems and methods can use both the forward and the backward frames as the references, and the average boundary variance of the four neighboring blocks (top, down, left, right) can be calculated, if available. The motion search can be preformed within a search range, using the median motion vector of the neighboring blocks (up, left, up-left) as the initial value. After the motion search, the average of the target blocks in the two references can be used to fill the pixel values. However in some cases, BM does not perform well (e.g., when the block boundary is a horizontal/vertical edge), which may give a wrong matching.

According to a further non-limiting embodiment, the provided systems and methods can first check whether adjacent blocks have such edges. For example, if the upper block has a horizontal line at the bottom, it can be discarded and not used in the calculation of boundary variance. According to a further non-limiting embodiment, the provided systems and methods can first check whether adjacent blocks have such edges using a Sobel operator to check the horizontal/vertical line in the area of the reference frame, indicated by the motion vector of the checked block.

TLTI Comparison with UMCTI

The following simulation results are provided herein to help enable an appreciation of the beneficial aspects of exemplary, non-limiting embodiments described above and in the accompanying drawings. The simulation and simulation parameter are not intended, however, as an extensive or exhaustive presentation of the possible embodiments, but rather illustrate the beneficial aspects of a particular non-limiting embodiment. As such, parameter values listed and other descriptions of the particular embodiment in the following paragraphs should not be taken to limit the disclosed systems and methods, but should be appreciated as one possible implementation of the invention under the circumstances of the particular simulation specification.

Accordingly, the performance of TLTI is compared with UMCTI, and is shown by both visual and quantitive results. The simulation used the JVT reference software version 8.2 (baseline profile) for the simulations. The first 300 frames of video sequences Carphone and Sales (QCIF) are encoded at 15 fps, and only the first frame is an 1 frame. At the encoder side, ref_idx_{—}10 is specified for each P frame to simulate the odd/even subsampling MDC. For the I frame, it is sent only twice to the decoder side, since the main focus of the simulation is to compare the performance of temporal interpolation, instead of the compression efficiency of MDC. During the concealment, constant thresholds are used for TLTI: SIZEₜ=8, MVₜ=3\sqrt{2} and Δₜ=3\sqrt{2}. For UMCTI, the preserved motion vector in the correct stream for the interpolation is also used, thus reducing the computation time.

### TLTI Qualitative Improvements

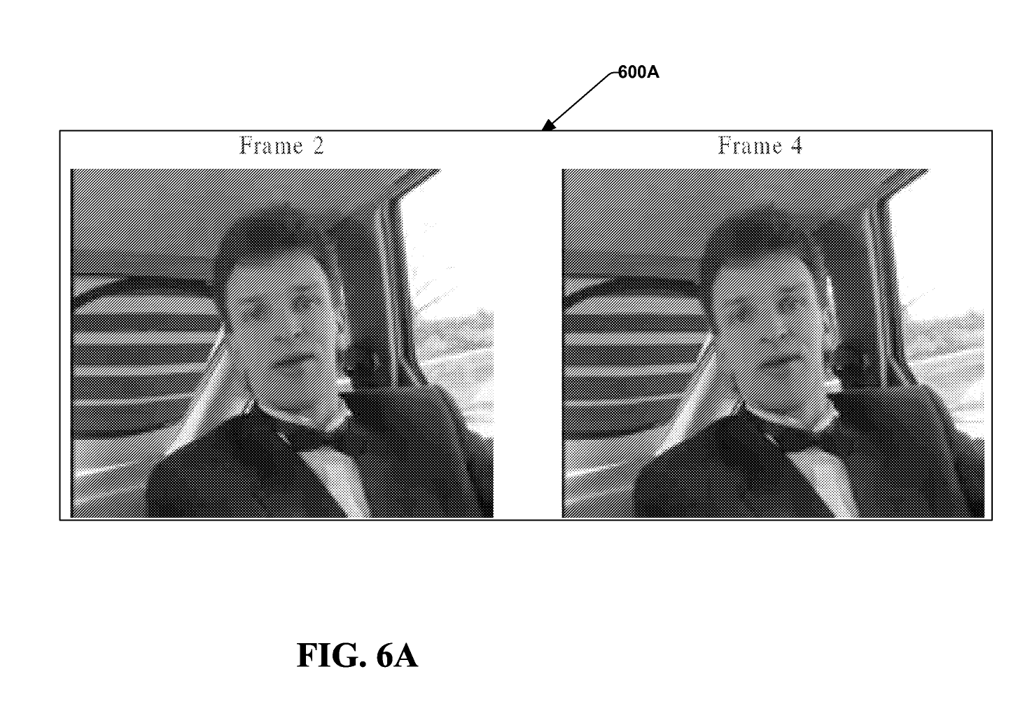

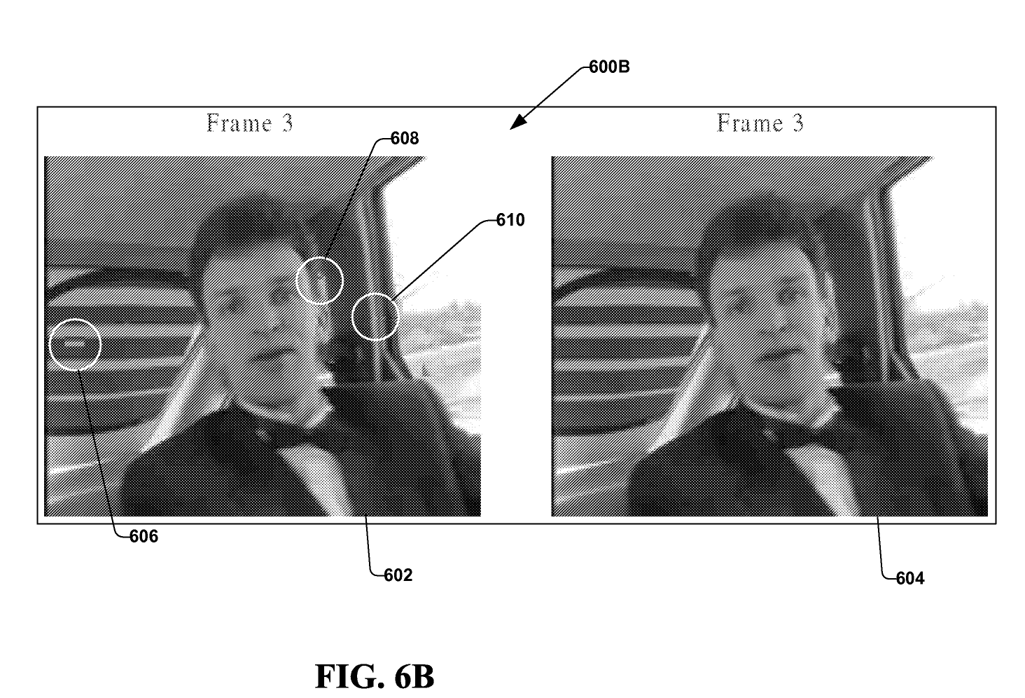

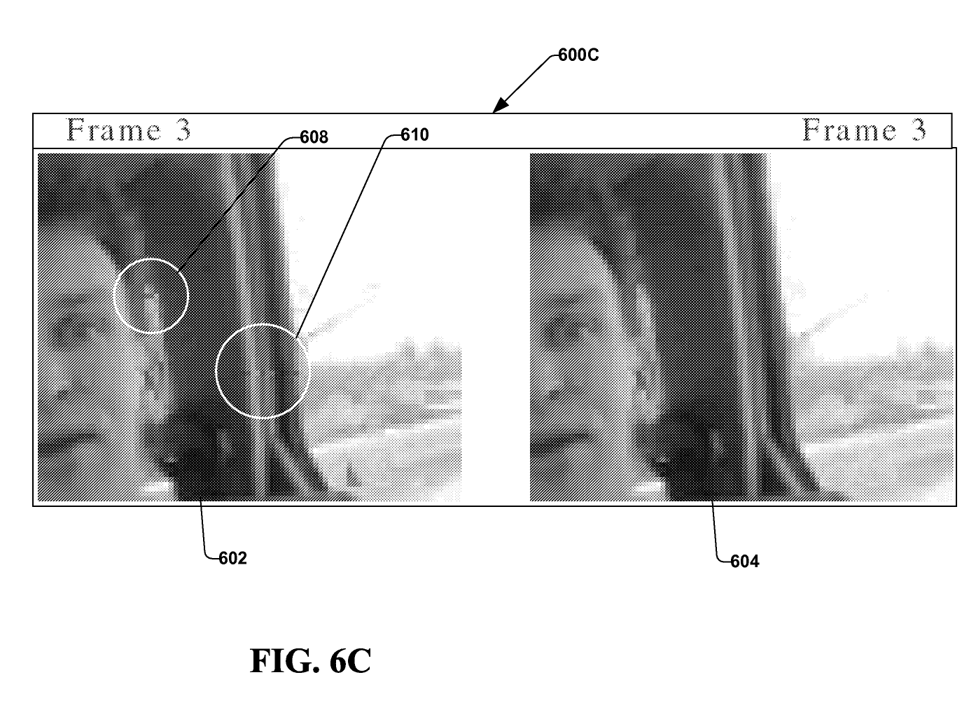

FIG. 6 illustrates the visual quality improvement of TLTI over UMCTI. Fixed Quantization Parameter (QP) is used for the encoding, 27 for I frame and 29 for P frame. FIG. 6A depicts the reference frames of the video sequence Carphone, for one frame lost (frame 3) (e.g., it depicts the original encoded frames 2 and 4 without lost frame 3). FIG. 6B depicts the visual results of applying UMCTI and TLTI on the video sequence Carphone (i.e., the reconstructed frame 3) using UMCTI (PSNR=29.79 dB) and TLTI (PSNR=30.33 dB) indicating remaining artifacts (606, 608, 610) in the UMCTI reconstructed frame 602. FIG. 6C is an enlarged version of the results in FIG. 6B depicting visual results of applying UMCTI and TLTI on the video sequence Carphone (i.e., the reconstructed frame 3) using UMCTI (PSNR=29.79 dB) and TLTI (PSNR=30.33 dB) indicating remaining artifacts (608, 610) in the UMCTI reconstructed frame 602.

In FIGS. 6B and 6C, the UMCTI reconstructed frame 602 appears on the left with the aforementioned artifacts (606, 608, 610), while the improved TLTI frame 604 reconstruction according to one embodiment of the present invention appears on the right with the artifacts. From these figures it is apparent that the error concealed frame using TLTI looks much better than that using UMCTI, especially around object boundaries. Advantageously, TLTI introduces less blocky artifacts.

### TLTI Quantitative Improvements

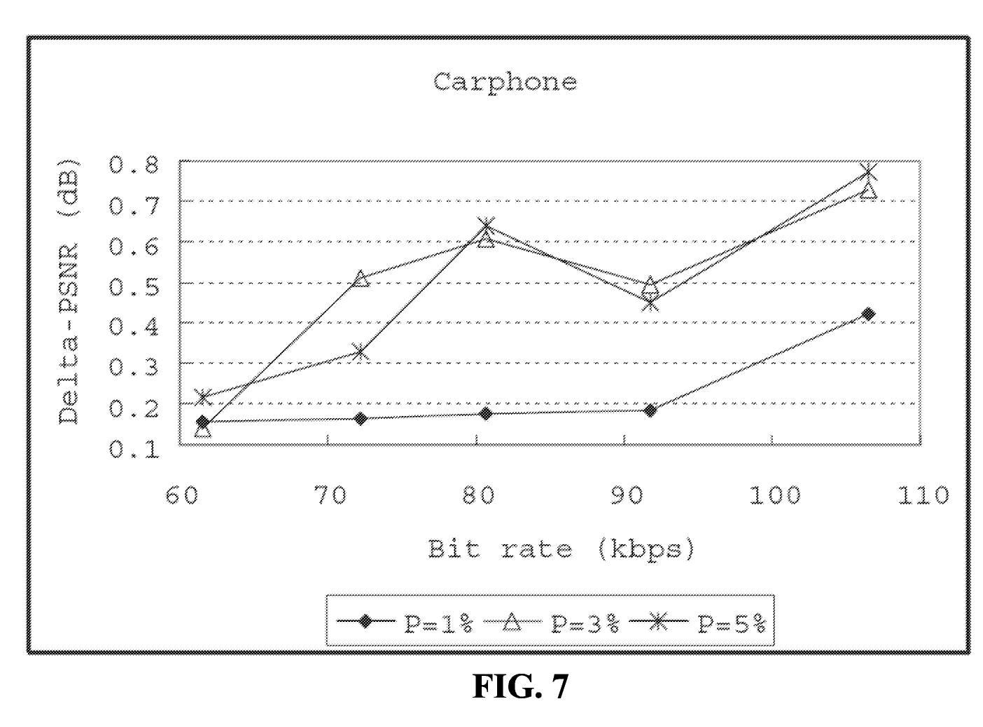

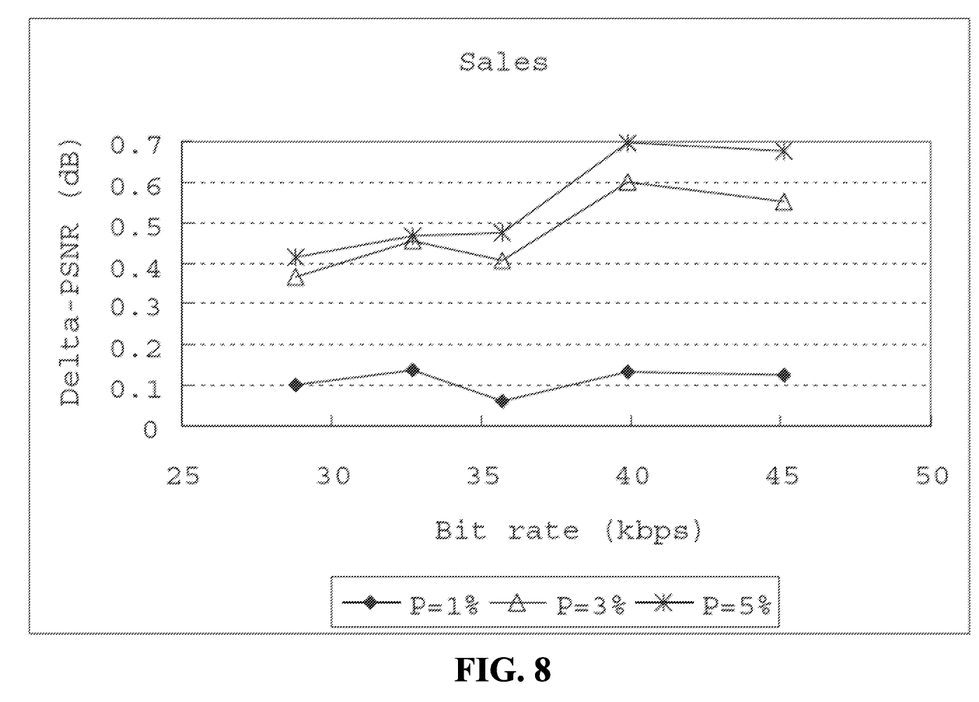

The performance of UMCTI and TLTI, under random packet loss conditions can show similar but quantitative improvements of the present invention. Supposing the failure probability of each channel is independent and identically distributed with probability P; P=1%, 3% and 5% and one packet contains the information of one frame, the loss of one packet will lead to the loss of one entire frame. Five different bit rates are selected for the compression of each sequence. For each combination of loss rate (P) and bit rate, the video sequence is transmitted 40 times. At the decoder side, UMCTI or TLTI is used to reconstruct the lost frames, and the average Peak Signal-to-Noise Ratio (PSNR) is computed, compared to the original encoded one. Note that these two algorithms work for the condition of one frame loss, i.e., the surrounding two frames are received from the other channel and reconstructed with/without error. For continuous losses at the decoder side the typical response requires copying previous frame to reconstruct the video resulting in a freeze. The delta-PSNR between TLTI and UMCTI (e.g. delta-PSNR=PSNR_{TLTI}−PSNR_{UMCTI}) is obtained for the 40 transmissions, and its average value is plotted in FIGS. 7 and 8 for the two video sequences Carphone and Sales, respectively. Advantageously, according the particular embodiment, it is apparent that in all the testing cases, TLTI can obtain a higher average PSNR than UMCTI, especially when the loss rate is higher.

Thus the disclosed systems and methods for error concealment of multiple description coding (MDC) encoded streams named Three-loop Temporal Interpolation is shown to provide visual and quantitative improvements. Simulation results show that TLTI can reconstruct the lost frame with a higher quality than UMCTI.

### Exemplary Video Stream Processing System

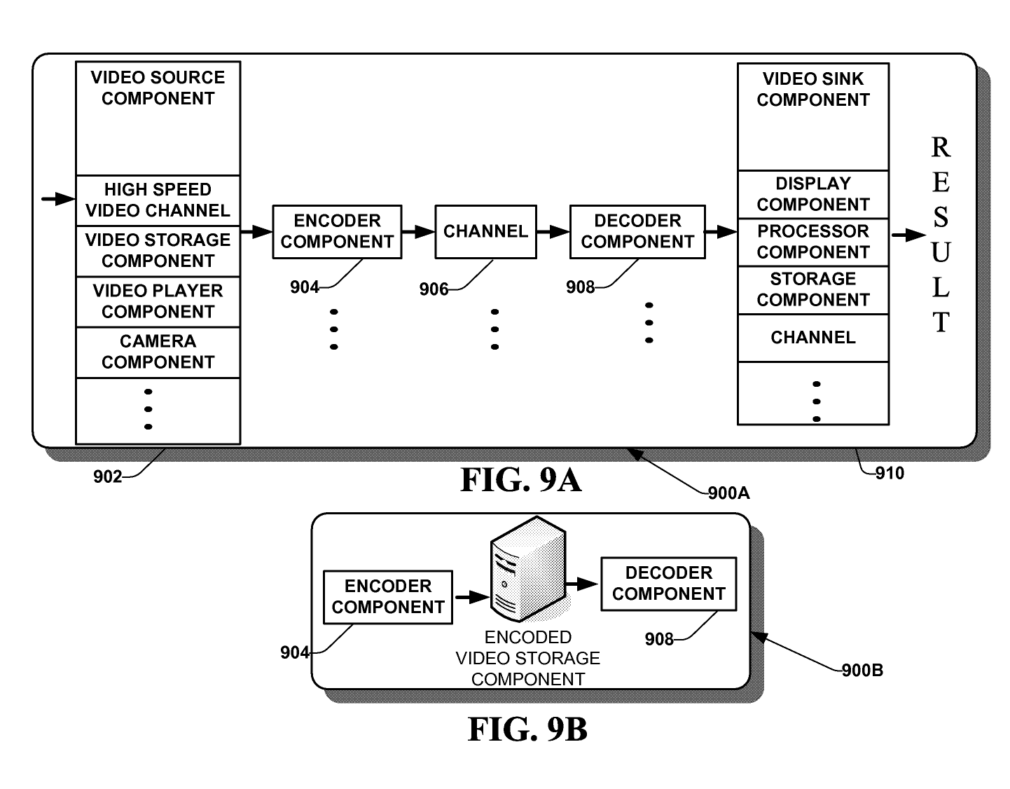

FIG. 9 is a block diagram of an exemplary non-limiting embodiment of a video stream processing system 900A and 900B suitable for practicing the present invention. The system accepts video data from any number of source components 902, encodes it using an encoder component 904 such that the video data is encoded for transport or storage. System 900A includes a decoder component 908 that receives the transported or stored video data and decodes it for use by any number of video sink components.

In a basic operation, video data, typically unencoded video data, is provided to encoder component 904, which encodes the video data, typically to form compressed video data that occupies fewer bits than the uncompressed video data, which then makes the compressed video data available to the decoder component (via a channel 906, storage component, or a combination thereof). The decoder component 908 in turn decompresses the compressed video data produce a substantially exact or approximate representation of the uncompressed video data provided to the input of the encoder component 904.

Video source components can include, for example, include a high-speed video channel (e.g., a cable or broadcast link capable of transmitting unencoded or partially encoded video data, video storage component (e.g., storage of unencoded or partially encoded video data), a camera component, or a video player component (e.g., a VCR or DVD player. Possible video sinks, for example, could include a display component (e.g., a monitor, television, a device LCD screen), a video processor component (e.g., video capture device, video processor algorithms operating on a special or general purpose processor, video editing device), video storage component that can store encoded or decoded video data, or another channel for subsequent transmission.

FIG. 9A illustrates an example 900A where video is encoded for transmission over a channel 906. By way of example channel 906, could be a digital subscriber line (DSL), a cable modem, a dialup connection, broadcast, cable broadcast, satellite transmission, 802.11 Wireless link, internal signal bus, direct cable link (e.g., USB or IEEE-1394 or FIREWIRE link, and the like), or any other link (e.g., wired or wireless) suitable for the transmission of video data. In such cases, the video is encoded so that it can be transmitted using available bandwidth efficiently. For the purpose of the present invention, the channel 906 is subject to conditions presumed to cause frame loss transmission errors, which can be concealed using the disclosed systems and methods.

FIG. 9B illustrates an example of a system 900B where video is encoded for storage. As shown, encoder 904 encodes video data for storage in encoded video storage component for later retrieval by decoder 908. The encoded video storage component can take any suitable form of sufficient capacity (e.g., a memory card, a personal video recorder (PVR), a hard disk drive, RAM, DVD, CD, or any other suitable storage).

It is to be understood that the video stream processing system is illustrated generally to understand the basic operation of the present invention. As such, the system depiction should not be viewed as limiting the claimed invention. Further to the point and as more fully described below, although components are shown on the figures as discrete blocks, any number of such components may be combined into a single device, integrated into a single multi-function chip, or distributed across multiple local or remote devices as the designer desires or as the system architecture requires without changing the nature and operation of the claimed invention.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with the error concealment systems and methods in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes. Digital video processing, and thus the techniques for error concealment in accordance with the present invention can be applied with great efficacy in those environments.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods of error concealment of the invention.

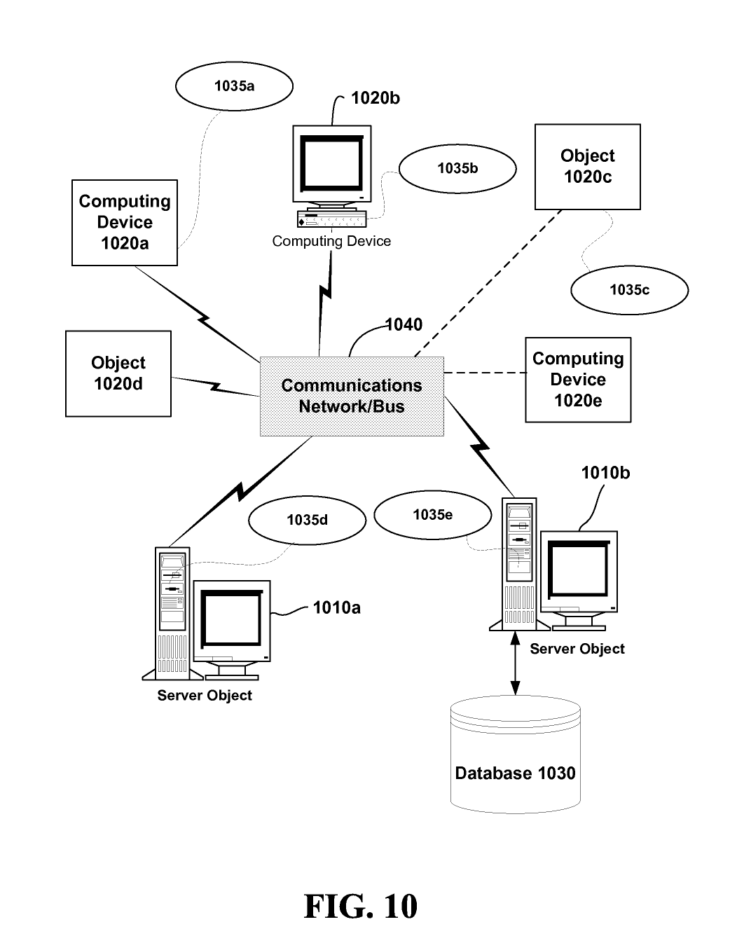

FIG. 10 provides a schematic diagram of an exemplary networked or distributed computing environment. The distributed computing environment comprises computing objects 1010a, 1010b, etc. and computing objects or devices 1020a, 1020b, 1020c, 1020d, 1020e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1040. This network may itself comprise other computing objects and computing devices that provide services to the system of FIG. 10, and may itself represent multiple interconnected networks. In accordance with an aspect of the invention, each object 1010a, 1010b, etc. or 1020a, 1020b, 1020c, 1020d, 1020e, etc. may contain an application that might make use of an API, or other object, software, firmware and/or hardware, suitable for use with the systems and methods for error concealment in accordance with the invention.

It can also be appreciated that an object, such as 1020c, may be hosted on another computing device 1010a, 1010b, etc. or 1020a, 1020b, 1020c, 1020d, 1020e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to error concealment according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 10, as an example, computers 1020a, 1020b, 1020c, 1020d, 1020e, etc. can be thought of as clients and computers 1010a, 1010b, etc. can be thought of as servers where servers 1010a, 1010b, etc. maintain the data that is then replicated to client computers 1020a, 1020b, 1020c, 1020d, 1020e, etc., although any computer can be considered a client, a server, or both, depending on the circumstances. Any of these computing devices may be processing data or requesting services or tasks that may implicate the error concealment systems and methods in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for error concealment of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 10 illustrates an exemplary networked or distributed environment, with server(s) in communication with client computer (s) via a network/bus, in which the present invention may be employed. In more detail, a number of servers 1010a, 1010b, etc. are interconnected via a communications network/bus 1040, which may be a LAN, WAN, intranet, GSM network, the Internet, etc., with a number of client or remote computing devices 1020a, 1020b, 1020c, 1020d, 1020e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to conceal errors in received video data according to the disclosed TLTI systems and methods.

In a network environment in which the communications network/bus 1040 is the Internet, for example, the servers 1010a, 1010b, etc. can be Web servers with which the clients 1020a, 1020b, 1020c, 1020d, 1020e, etc. communicate via any of a number of known protocols such as HTTP. Servers 1010a, 1010b, etc. may also serve as clients 1020a, 1020b, 1020c, 1020d, 1020e, etc., as may be characteristic of a distributed computing environment.

As mentioned, communications may be wired or wireless, or a combination, where appropriate. Client devices 1020a, 1020b, 1020c, 1020d, 1020e, etc. may or may not communicate via communications network/bus 14, and may have independent communications associated therewith. For example, in the case of a TV or VCR, there may or may not be a networked aspect to the control thereof. Each client computer 1020a, 1020b, 1020c, 1020d, 1020e, etc. and server computer 1010a, 1010b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 1010a, 1010b, 1020a, 1020b, 1020c, 1020d, 1020e, etc. may be responsible for the maintenance and updating of a database 1030 or other storage element, such as a database or memory 1030 for storing data processed or saved according to the invention. Thus, the present invention can be utilized in a computer network environment having client computers 1020a, 1020b, 1020c, 1020d, 1020e, etc. that can access and interact with a computer network/bus 1040 and server computers 1010a, 1010b, etc. that may interact with client computers 1020a, 1020b, 1020c, 1020d, 1020e, etc. and other like devices, and databases 1030.

### Exemplary Computing Device

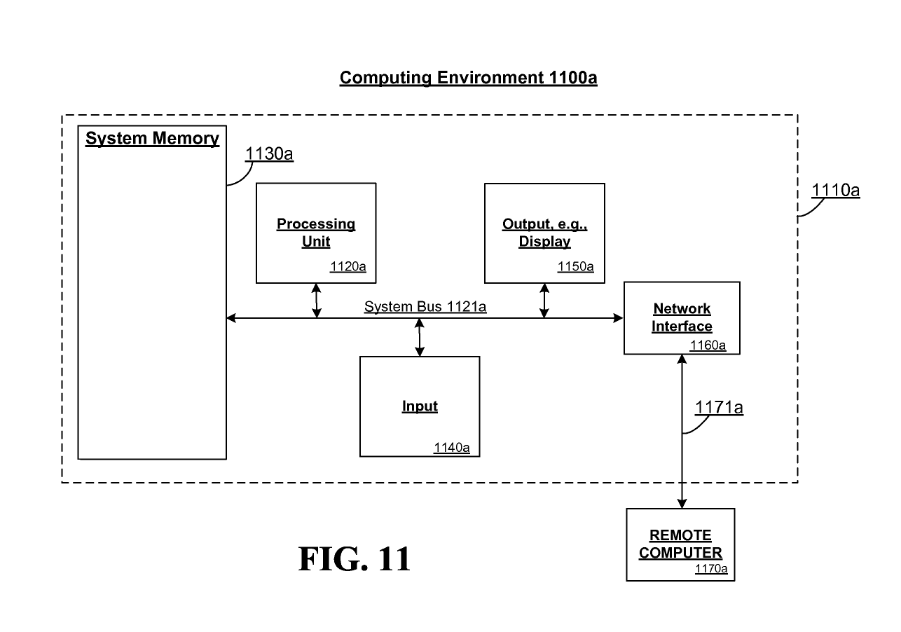

As mentioned, the invention applies to any device wherein it may be desirable to conceal errors in received encoded video data. It should be understood, therefore, that handheld, portable and other computing devices and computing objects of all kinds are contemplated for use in connection with the present invention, i.e., anywhere that a device may receive or otherwise process or store data video data. Accordingly, the below general purpose remote computer described below in FIG. 11 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 11 thus illustrates an example of a suitable computing system environment 1100a in which the invention may be implemented, although as made clear above, the computing system environment 1100a is only one example of a suitable computing environment for a media device and is not intended to suggest any limitation as to the scope of use or functionality of the invention. Neither should the computing environment 1100a be interpreted as having any dependency or requirement relating to any one or combination of components illustrated in the exemplary operating environment 1100a.

With reference to FIG. 11, an exemplary remote device for implementing the invention includes a general purpose computing device in the form of a computer 1110a. Components of computer 1110a may include, but are not limited to, a processing unit 1120a, a system memory 1130a, and a system bus 1121a that couples various system components including the system memory to the processing unit 1120a. The system bus 1121a may be any of several types of bus structures including a memory bus or memory controller, a peripheral bus, and a local bus using any of a variety of bus architectures.

Computer 1110a typically includes a variety of computer readable media. Computer readable media can be any available media that can be accessed by computer 1110a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1110a. Communication media typically embodies computer readable instructions, data structures, program modules or other data in a modulated data signal such as a carrier wave or other transport mechanism and includes any information delivery media.

The system memory 1130a may include computer storage media in the form of volatile and/or nonvolatile memory such as read only memory (ROM) and/or random access memory (RAM). A basic input/output system (BIOS), containing the basic routines that help to transfer information between elements within computer 1110a, such as during start-up, may be stored in memory 1130a. Memory 1130a typically also contains data and/or program modules that are immediately accessible to and/or presently being operated on by processing unit 1120a. By way of example, and not limitation, memory 1130a may also include an operating system, application programs, other program modules, and program data.

The computer 1110a may also include other removable/non-removable, volatile/nonvolatile computer storage media. For example, computer 1110a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1121a through a non-removable memory interface such as an interface, and a magnetic disk drive or optical disk drive is typically connected to the system bus 1121a by a removable memory interface, such as an interface.

A user may enter commands and information into the computer 1110a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1120a through user input 1140a and associated interface(s) that are coupled to the system bus 1121a, but may be connected by other interface and bus structures, such as a parallel port, game port or a universal serial bus (USB). A graphics subsystem may also be connected to the system bus 1121a. A monitor or other type of display device is also connected to the system bus 1121a via an interface, such as output interface 1150a, which may in turn communicate with video memory. In addition to a monitor, computers may also include other peripheral output devices such as speakers and a printer, which may be connected through output interface 1150a.

The computer 1110a may operate in a networked or distributed environment using logical connections to one or more other remote computers, such as remote computer 1170a, which may in turn have media capabilities different from device 1110a. The remote computer 1170a may be a personal computer, a server, a router, a network PC, a peer device or other common network node, or any other remote media consumption or transmission device, and may include any or all of the elements described above relative to the computer 1110a. The logical connections depicted in FIG. 11 include a network 1171a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1110a is connected to the LAN 1171a through a network interface or adapter. When used in a WAN networking environment, the computer 1110a typically includes a communications component, such as a modem, or other means for establishing communications over the WAN, such as the Internet. A communications component, such as a modem, which may be internal or external, may be connected to the system bus 1121a via the user input interface of input 1140a, or other appropriate mechanism. In a networked environment, program modules depicted relative to the computer 1110a, or portions thereof, may be stored in a remote memory storage device. It will be appreciated that the network connections shown and described are exemplary and other means of establishing a communications link between the computers may be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the methods for error concealment in an decoded video stream in accordance with the invention may be included in, supported in or accessed via all of the languages and services enabled by managed code, such as .NET code, and in other distributed computing frameworks as well.

There are multiple ways of implementing the present invention, e.g., an appropriate API, tool kit, driver code, operating system, control, standalone or downloadable software object, etc. which enables applications and services to use the systems and methods for digital video error concealment of the invention. The invention contemplates the use of the invention from the standpoint of an API (or other software object), as well as from a software or hardware object that performs TLTI for error concealment in a MDC stream in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to conceal errors in received encoded video data. For instance, the systems and methods of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the error concealment methods of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIGS. 1-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for concealment of errors in a MDC stream. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for using temporal interpolation to construct a frame of a temporal subsampled data stream, the method comprising:
receiving a temporal subsampled data stream for which a frame is to be constructed;
calculating determined motion vectors for respective blocks of the frame having defined determined motion vectors;
calculating candidate motion vectors for respective blocks of the frame having undefined determined motion vectors;
filling pixel values for the blocks having defined determined motion vectors based, at least in part, on the respective determined motion vectors;
determining whether credible candidate motion vectors exist for at least a subset of unfilled respective blocks of the frame based, at least in part, on a credibility criteria;
filling pixel values for the blocks having existing credible candidate motion vectors based, at least in part, on the respective existing credible candidate motion vectors; and
filling pixel values for at least a subset of the remaining unfilled respective blocks of the frame using a boundary matching calculation.

2. The method of claim 1, wherein the receiving includes receiving a multiple description coding encoded stream.

3. The method of claim 2, wherein the receiving includes receiving an odd/even sub-sampled multiple description coding encoded stream.

4. The method of claim 1, wherein the receiving includes receiving an alternative motion compensated prediction encoded stream.

5. The method of claim 1, further comprising:
dividing the frame to be constructed into blocks with size M by N, where M(N) is a factor of the frame height(width).

6. The method of claim 1, further comprising:
determining whether a determined motion vector is defined or undefined based, at least in part, on one or more threshold criteria.

7. The method of claim 6, wherein the one or more threshold criteria includes at least one of a minimum allowed overlap region and a maximum allowed motion vector.

8. The method of claim 1, wherein the determining includes determining whether credible candidate motion vectors exist for at least a subset of unfilled respective blocks of the frame based, at least in part, on a threshold smoothness between the respective motion vectors of the block of interest and at least a subset of the surrounding blocks.

9. The method of claim 1, wherein the step of filling pixel values for the at least a subset of the remaining unfilled respective blocks of the frame using a boundary matching calculation includes performing an edge detection to discard edge blocks prior to using the boundary matching calculation.

10. A computer readable medium comprising computer executable instructions for performing the method of claim 1.

11. A computing device comprising means for performing the method of claim 1.

12. A video decoder system for constructing a frame of a temporal subsampled data stream using temporal interpolation comprising:
motion vector determining means for calculating at least one of determined or candidate motion vectors for respective blocks of the frame based, at least in part, on whether the respective determined motion vector is defined or undefined;
credibility determining means for determining whether credible candidate motion vectors exist for the respective frame blocks with undefined determined motion vectors based, at least in part, on a credibility threshold;
boundary matching means for performing a boundary matching calculation; and
edge detection means for performing an edge detection and discarding edge blocks prior to performing the boundary matching calculation; and
pixel filling means for filling pixel values for frame blocks based, at least in part, on the respective determined motion vectors, on the respective existing credible candidate motion vectors, or on performing the boundary matching calculation.

13. The system of claim 12, wherein the temporal subsampled data stream includes a multiple description coding encoded stream or a motion compensated prediction encoded stream.

14. The system of claim 12, wherein the frame to be constructed is divided into blocks with size M by N, where M(N) is a factor of the frame height(width).

15. The system of claim 12, wherein the status of whether a determined motion vector is defined or undefined is based, at least in part, on a minimum allowed overlap parameter or a maximum allowed motion vector.

16. The system of claim 12, wherein the credibility threshold is based, at least in part, on a smoothness characteristic between the respective motion vectors of the block of interest and one or more of the surrounding blocks.

17. A computing device for error concealment using temporal interpolation to construct a frame of a temporal subsampled data stream, comprising:
a calculating component for calculating determined motion vectors for respective blocks of the frame having defined determined motion vectors;
a determining component for determining candidate motion vectors for respective blocks of the frame having undefined determined motion vectors;
a credibility component for determining whether credible candidate motion vectors exist for respective blocks of the frame based, at least in part on a credibility criteria;
a pixel filler for filling frame block pixel values where determined motion vectors are defined based, at least in part, on the respective determined motion vectors and where credible candidate motion vectors exist based, at least in part, on the respective existing credible candidate motion vectors; and
a boundary matching component performing a boundary matching calculation for filling pixel values for at least a subset of the remaining unfilled frame blocks.

18. The computing device of claim 17, further comprising an edge detection component for performing an edge detection for discarding edge blocks prior to performing the boundary matching calculation.

19. The computing device of claim 17, wherein the calculating and determining components further comprise one or more status checking components to determine whether a determined motion vector is defined or undefined based, at least in part, on a minimum allowed overlap region.

20. The computing device of claim 17, wherein the calculating and determining components further comprise one or more status checking components to determine whether a determined motion vector is defined or undefined based, at least in part, on a maximum allowed motion vector.
